(19) United States
(12) Patent Application Publication
(10) Pub. No.: US 2007/0152636 A1
(43) Pub. Date: Jul. 5, 2007

(54) Battery, equipment, and methods of putting such a battery and such equipment into a storage condition

(75) Inventor: Michel Nollet, Noisy le Roi (FR)

Correspondence Address: BIRCH STEWART KOLASCH & BIRCH, PO BOX 747, FALLS CHURCH, VA, 22040-0747, US

(73) Assignee: SAGEM DEFENSE SECURITE, Paris (FR)

(21) Appl. No.: 11/640,180

(22) Filed: Dec. 18, 2006

(30) Foreign Application Priority Data
Dec. 19, 2005 (FR) 05 12880

(51) Int. Cl. H02J 7/00

(52) U.S. Cl. 320/127

(57) ABSTRACT

The invention relates to a battery provided with a self-discharge circuit comprising an activation element for activating the self-discharge circuit and at least one current-consuming element connected to terminals of the battery via a connection member that can be actuated selectively to go into a self-discharge circuit connection state or to go into a self-discharge circuit disconnection state, and that is caused to disconnect the self-discharge circuit at a predetermined charge state that is less than a rated charge state of the battery. The invention also relates to equipment provided with a discharge circuit for discharging the battery, and to methods of putting such a battery or such equipment into a storage condition.

The present invention relates to a battery such as a lithium-ion (Li-ion) battery, usable in particular for powering a handheld electrical unit, and also relates to equipment incorporating such a unit. The invention also relates to methods of putting such a battery and such equipment into a storage condition.

### BACKGROUND OF THE INVENTION

Storing such a battery for a long period (longer than two months) requires certain precautions to be taken in order to avoid damaging the battery since there is a risk that such damage might degrade performance. In addition to the place of storage, such precautions concern the charge state of the battery at the time at which it is put into storage. There is a risk that the battery might be degraded if its charge state at the time of storage is close to its rated charge state. For that reason, battery manufacturers recommend storing their batteries at a charge state of less than 50% of the rated charge state.

It has thus been devised to use special apparatus for discharging the battery prior to storage. Unfortunately, such apparatus is costly and raises logistics problems when the stock of batteries is large. Charger/discharger apparatus has also been imagined: the structure of such apparatus would be complex and also costly.

Apparatus is also known for discharging batteries prior to charging them so as to avoid the appearance of a memory effect. Such discharging apparatus is thus arranged so as to guarantee that the batteries are discharged fully.

### OBJECT OF THE INVENTION

An object of the invention is to provide simple means for storing batteries without degrading them.

### SUMMARY OF THE INVENTION

To this end, the invention provides a battery provided with a self-discharge circuit comprising an activation element for activating the self-discharge circuit and at least one resistive element connected to terminals of the battery via a connection member that can be actuated selectively to go into a self-discharge circuit connection state or to go into a self-discharge circuit disconnection state, and that is caused to disconnect the self-discharge circuit at a predetermined charge state that is less than a rated charge state of the battery and that is compatible with storage of the battery.

Thus, it is merely necessary to activate the discharge circuit integrated in the battery at the beginning of storage in order to bring the battery to a charge state that is compatible with storage, with the self-discharge circuit then being disconnected automatically.

Preferably, the self-discharge circuit further comprises a comparator connected to the terminals of the battery for the purpose of detecting a voltage, and connected to the interrupter switch for disconnecting the self-discharge circuit when the voltage is less than a predetermined threshold.

This embodiment is particularly simple.

Advantageously, the predetermined charge state lies in the range 20% of the rated charge state of the battery to 40% of said rated charge state of said battery, and preferably, the predetermined charge state is equal to about 30% of the rated charge level of the battery.

These charge state values make it possible to preserve the battery regardless of the length of time for which it is stored.

In a particular embodiment, the battery includes a consumption management circuit integrated therein and at least a portion of which is arranged to form the self-discharge circuit.

Using the consumption management circuit of the battery as a self-discharge circuit makes it possible to limit the weight of the battery by imparting an additional, discharge function to the consumption management circuit that is already present in the battery.

Preferably, the resistive element is dimensioned so as to make it possible for the battery to be discharged from its rated charge state to the predetermined charge state within a period of two months.

It is known that storage for two months does not degrade a battery that has a charge state greater than the charge state recommended for long-term storage. By allowing two months for the battery to discharge, it is possible to discharge via a resistive element that is relatively compact.

The invention also provides equipment including an electrical unit powered by a battery, said equipment further including a discharge circuit for discharging the battery, which circuit includes at least one current-consuming element connected to terminals of the battery via a connection member that can be actuated selectively to go into a self-discharge circuit connection state or to go into a self-discharge circuit disconnection state, and that is caused to disconnect the self-discharge circuit at a predetermined charge state that is less than a rated charge state of the battery.

The invention also provides methods of putting a battery and equipment of the type of the invention into a storage condition, said methods comprising the step of actuating the connection member so as to cause it to go into its connection state prior to storage.

Other characteristics and advantages of the invention will appear on reading the following description of particular non-limiting embodiments of the invention.

### BRIEF DESCRIPTION OF THE DRAWINGS

Reference is made below to the accompanying drawings, in which:

FIG. 1 is a simplified diagrammatic view of a first embodiment of a battery of the invention;

FIG. 2 is a simplified diagrammatic view of a second embodiment of a battery of the invention;

FIG. 3 is a view analogous to FIG. 2, showing a variant of the second embodiment; and

FIG. 4 is a view analogous to FIG. 1, showing equipment of the invention.

### DETAILED DESCRIPTION OF THE INVENTION

With reference to FIG. 1, the battery of the invention, designated by overall reference 1, is, in this example an Li-ion battery, and, in a manner known per se, it comprises a series of electrodes, represented at 2, associated with an electrolyte and connected to connection terminals 3 that are external to the battery 1.

In accordance with the invention, the battery 1 includes a self-discharge circuit designated by overall reference 4 and including a resistive element 5 connected to the terminals 3 via a switch 6 that can be actuated selectively into a connection state in which the self-discharge circuit 4 is connected to the terminals 3 or into a disconnection state in which the self-discharge circuit 4 is disconnected.

The resistive element 5 is, in this example, merely a resistor dimensioned to guarantee that the battery 1 is discharged from its rated charge state to a storage charge state within a period of two months. The storage charge state lies in the range 20% of the rated charge state of the battery 1 to 40% of the rated charge state thereof, and, more precisely, it is equal to about 30% of the rated charge state of the battery 1.

The switch 6 is associated with a comparator 7 which is connected to the terminals 3 of the battery 1 so as to detect a voltage across them and that is arranged to bring the switch 6 from its connection state to its disconnection state. A button 8 mounted on the case of the battery 1 is connected to the switch 6 so as to bring the switch 6 from its disconnection state to its connection state.

When the battery 1 is in normal use, i.e. when it is powering a unit or when it is being charged or being stored for a short time, the switch 6 is in its disconnection state.

When the battery 1 is to be stored for a time longer than two months, an operator actuates the switch 6 to move it into its connection state by means of the button 8 mounted on the case of the battery 1. The button 8 and the switch 6 thus form an activation element for activating the self-discharge circuit 4 while the switch 6 also forms a connection member for connecting the resistive element 5 to the terminals 3.

The battery 1 then discharges into the resistive element 5 so long as the voltage across the terminals 3 of the battery 1 is greater than a predetermined threshold that is representative of the storage charge state.

When the voltage is less than said predetermined threshold, the comparator 7 causes the switch 6 to go to its disconnection state in order to disconnect the self-discharge circuit.

In order to interrupt the battery being in its storage, it is merely necessary to actuate the button 8 so as to bring the switch 6 back into its disconnection state.

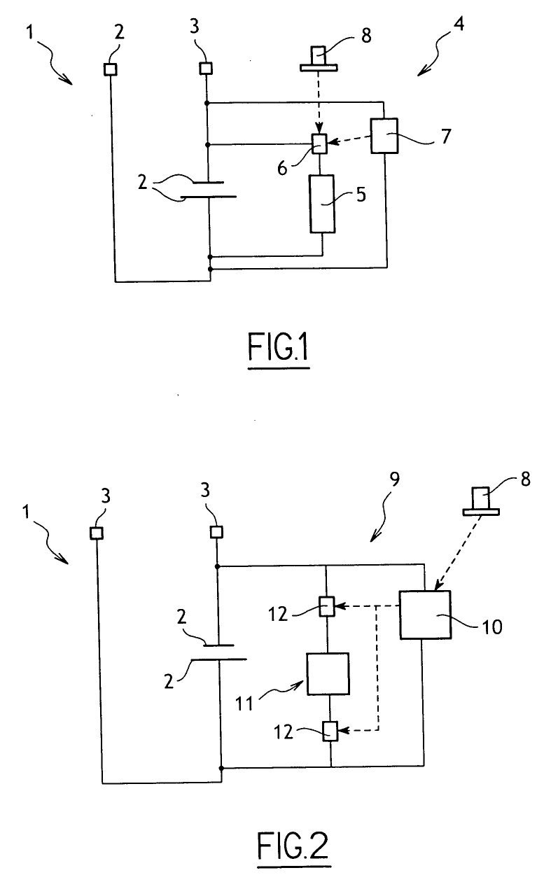

Elements that are identical or analogous to the above-described elements are given like numerical references in the following description of the second embodiment that is shown in FIG. 2.

In this embodiment, the battery 1 includes a consumption management circuit 9 that is known per se. The consumption management circuit 9 is connected to the terminals 3 and it includes a management unit 10 that, for example, comprises a microprocessor arranged to execute computer programs. The management unit 10 is connected to the button 8 mounted on the case of the battery 1. The management unit 10 is also connected to the terminals 3 so as to detect the voltage across them, and it is arranged to compare said voltage with a predetermined threshold.

The management circuit 9 is used conventionally while the battery 1 is operating normally.

When the button 8 is actuated, the management unit 10 activates a self-discharge program that uses a portion 11 of the consumption management circuit as the self-discharge circuit. For example, the self-discharge program controls switches 12 so that they connect the portion 11 to the terminals 3 so long as the voltage across the terminals 3 is greater than the predetermined threshold. Said portion 11 includes a resistive element that consumes electrical power from the battery 1, but it can also have another function when the battery 1 is being used normally.

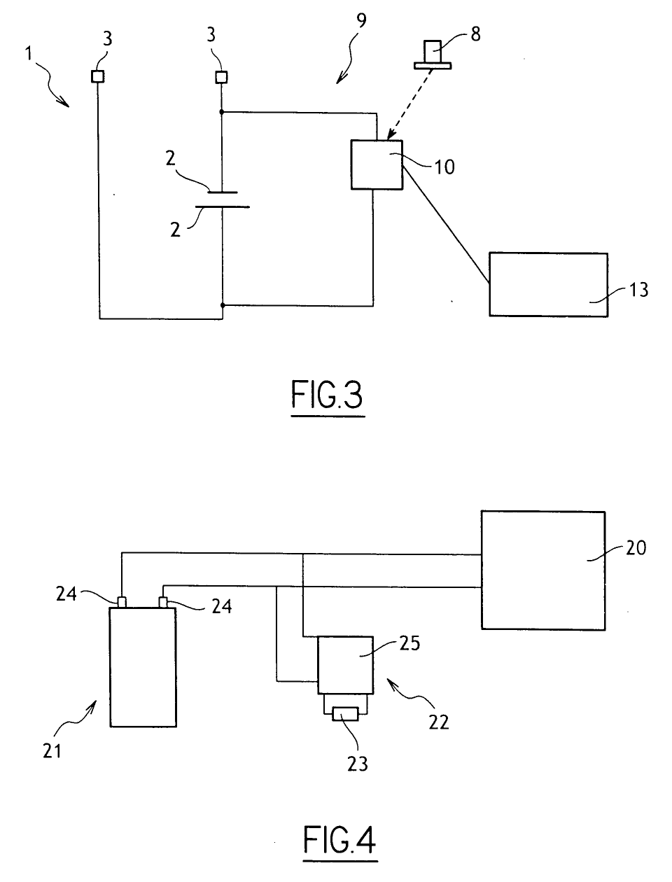

In the variant shown in FIG. 3, the case of the battery 1 is equipped with a backlit display 13 that is known per se and that is connected to the management unit 10 so as to display, for example, the charge level of the battery. A button (not shown) makes it possible to light up the display when the light conditions prevent it from being read.

In this variant, the self-discharge program causes the back-lit display 13 to be lighted up.

Lighting up the back-lit display 13 generates consumption of current that causes the battery 1 to discharge gradually, and makes it possible to be informed that the instruction for putting into storage has indeed been taken into account by the management circuit.

The self-discharge program switches off the lighting once the storage charge level is reached.

This makes it possible, in the place in which the batteries are stored, to identify rapidly those batteries which have reached their storage charge level. This makes it possible to facilitate stock management when, for example, a first-in-first-out (FIFO) strategy is put in place.

As a variant in this example, the lighting-up control button can, for example, also be used to activate the self-discharge program (short press: light up; and long press: put into storage).

Naturally, the invention is not limited to the embodiments described, but rather it covers any variant lying within the ambit of the invention as defined in the claims.

In particular, the self-discharge circuit 4 can have a structure different from the structure that is described. Thus, in a variant of the first embodiment, an interrupter switch can be mounted in series with the switch 6 and with the resistive element and can be associated with the comparator 7 which then controls said interrupter switch only. The self-discharge circuit can include a plurality of resistive elements in series. It should be noted that, in the invention, the current-consuming element is not necessarily a resistor in the strict sense, but rather it can be an electrical component or a group of electrical components presenting internal resistance or a current-consuming characteristic. The current-consuming element can thus be a lamp such as an indicator lamp formed of a light-emitting diode (LED). It is possible to provide a plurality of LEDs in order to indicate how the discharging is progressing: firstly, all of the LEDs are switched on, and they are then progressively switched off as the charge level comes closer to the storage charge level. It should be noted that the higher the charge level, the higher the consumption of the LEDs. The power to be dissipated is thus shared between a plurality of LEDs. It is also possible to organize the power dissipation between current-consuming elements of different types, such as one lamp and one resistive element.

In addition, the self-discharge circuit can operate differently from the operation described. The voltage can be measured on activating the self-discharge circuit and a self-discharge time required in order to reach the storage charge state can be determined, a time delay member interrupting the self-discharge circuit at the end of that time. The self-discharge circuit can also be activated automatically after a predetermined time of non-use.

If the battery does not have a charge state detector, the charge state can be detected by measuring:

the quantity of electricity (in coulombs) delivered and received by the battery;

the internal resistance of the battery; and

the voltage of the battery.

It is possible to dimension the current-consuming element so that it brings the battery to the storage charge state within a period of less than two months. The shorter the time, the higher the power that the current-consumption must be capable of dissipating.

It is also possible to provide means for automatically bringing the connection member from its connection state to its disconnection state when the storage state is interrupted. Putting the battery on charge can be the event that triggers going over to the disconnection state. The battery can thus include a charger detection circuit that causes the connection member to go into its disconnection state when the charger is detected. Similarly, the battery can incorporate a detection circuit for detecting the arrival of charging current or an increase in voltage consequent upon application of the charging current.

In a variant, as shown in FIG. 4, the discharge circuit can be external to the battery and be part of equipment. The equipment comprises an electrical unit 20 that is powered by a battery 21, and a discharge circuit 22 for discharging the battery 21. The discharge circuit 22 includes at least one current-consuming element 23 that is connected to the terminals 24 of the battery 21 via a connection member 25 that can be actuated selectively to go into a discharge circuit connection state or to go into a discharge circuit disconnection state and that is caused to disconnect the discharge circuit at a predetermined charge state that is less than a rated charge state of the battery 21. The current-consuming element can be external to the battery and to the unit, like the element shown in FIG. 4, or else it can be part of the unit 20.

What is claimed is:

1. A battery provided with a self-discharge circuit comprising an activation element for activating the self-discharge circuit and at least one current-consuming element connected to terminals of the battery via a connection member that can be actuated selectively to go into a self-discharge circuit connection state or to go into a self-discharge circuit disconnection state, and that is caused to disconnect the self-discharge circuit at a predetermined charge state that is less than a rated charge state of the battery and that is compatible with storage of the battery.

2. A battery according to claim 1, in which the self-discharge circuit further comprises a comparator connected to the terminals of the battery for the purpose of detecting a voltage, and connected to the interrupter switch for disconnecting the self-discharge circuit when the voltage is less than a predetermined threshold.

3. A battery according to claim 1, in which the predetermined charge state lies in the range 20% of the rated charge state of the battery to 40% of said rated charge state of said battery.

4. A battery according to claim 3, in which the predetermined charge state is equal to about 30% of the rated charge level of the battery.

5. A battery according to claim 1, including a consumption management circuit integrated therein and at least a portion of which is arranged to form the self-discharge circuit.

6. A battery according to claim 1, including a light-emitting indicator that is connected to the discharge circuit in order to form the current-consuming element.

7. A battery according to claim 1, in which the current-consuming element is dimensioned so that the battery can be discharged from its rated charge state to the predetermined charge state within a period of two months.

8. Equipment including an electrical unit powered by a battery, said equipment further including a discharge circuit for discharging the battery, which circuit includes at least one current-consuming element connected to terminals of the battery via a connection member that can be actuated selectively to go into a self-discharge circuit connection state or to go into a self-discharge circuit disconnection state, and that is caused to disconnect the self-discharge circuit at a predetermined charge state that is less than a rated charge state of the battery and that is compatible with storage of the battery.

9. A method of putting a battery according to claim 1 into a storage condition, said method comprising the step of actuating the connection member so as to cause it to go into its connection state prior to storage.

10. A method of putting equipment according to claim 8 into a storage condition, said method comprising the step of actuating the connection member so as to cause it to go into its connection state prior to the storage.
